(19) United States
(12) Patent Application Publication
(10) Pub. No.: US 2025/0256537 A1
(43) Pub. Date: Aug. 14, 2025

(54) ENDWISE TRANSPORTABLE IMPLEMENT WITH AUTOMATIC LATCHING TONGUE

(71) Applicant: Great Plains Manufacturing, Inc., Salina, KS (US)

(72) Inventors: James B. Cooper, New Cambria, KS (US); Kelli Marie Riffel, Smolan, KS (US); Benjamin Carrol Houghton, Gypsum, KS (US)

(21) Appl. No.: 18/437,858

(22) Filed: Feb. 9, 2024

(51) Int. Cl. B60D 1/42; A01B 59/04; A01B 73/02

(52) U.S. Cl. CPC B60D 1/42; A01B 59/04; A01B 73/02

(57) ABSTRACT

A towable implement that is shiftable between a wide field configuration and a narrow transport configuration using a folding tongue and vertically adjustable transport wheels. Shifting of the towable implement between the field and transport configurations can be accomplished primarily by hydraulic power, with little or no manual manipulation of implement components being required.

### BACKGROUND OF THE INVENTION

### 1. Field of the Invention

The present invention relates to towable implements that are used to perform various operations affecting soil or plants.

### 2. Description of the Related Art

Towable implements are pulled behind a prime mover (e.g., an operator-driven tractor or an autonomous tractor) and perform a variety of work tasks that promote, for example, agriculture crop production, property maintenance, and construction-related earthwork. Typically, it is desirable for towable implements, especially agricultural implements, to be as wide as possible so that more ground can be covered by each pass in the field, thereby saving time and fuel. However, transporting wide implements from one working location to another often requires the implement to be pulled over public roads by the prime mover. Pulling a wide implement over a public road can be dangerous for both for the driver of the prime mover and other drivers on the road.

It is, therefore, advantageous for wide towable implements to be provided with mechanisms for reducing the width of the implements during transport over roads. Some implements can be configured with multiple sections that can be folded upwardly, forwardly, or rearwardly to reduce the overall width of the implement for transport. However, the configurations of some implements are not conducive to being folded.

Another technique for reducing the width of implements during transport over a road is to rotate the implement sideways and tow the implement on the road from an end of the implement. This technique of rotating the implement to narrow its width for towing over the road is sometimes referred to as endwise transport. Over the years, various configurations for endwise transport of implements have been developed. However, conventional techniques for providing endwise transport require significant manual manipulation of various components of the implement in order to shift the implement between the widthwise working/field configuration and the endwise transport configuration.

Therefore, it would be desirable to have an implement that is readily shiftable between a widthwise field configuration and an endwise transport configuration without requiring substantial manual manipulation of implement components.

### SUMMARY OF THE INVENTION

One aspect of the present invention concerns a towable implement that is shiftable between a field configuration for operation in a field and an endwise transport configuration for transporting over a road. The towable implement comprises a frame, one or more work mechanisms supported by the frame and configured to perform work in the field, and a folding tongue pivotably coupled to the frame and shiftable between an unfolded position and a folded position. The tongue is in the unfolded position when the implement is in the field configuration and the tongue is in the folded position when the implement is in the endwise transport configuration. The towable implement further comprises a brace system for supporting the tongue in the unfolded position. The brace system comprises a brace bar pivotally coupled to the frame and an alignment bar pivotally coupled to the tongue. The brace bar and the alignment bar are pivotally coupled to one another.

Another aspect of the present invention concerns a towable implement that is shiftable between a field configuration for operation in a field and an endwise transport configuration for transporting over a road. The towable implement comprises a frame, one or more work mechanisms supported by the frame and configured to perform work in the field, and a plurality of field wheels for supporting the implement in the field configuration. The towable implement further comprises a plurality of transport wheels for supporting the implement in the endwise transport configuration and a folding tongue pivotably coupled relative to the frame and shiftable between an unfolded position and a folded position. The tongue is in the unfolded position when the implement is in the field configuration and the tongue is in the folded position when the implement is in the endwise transport configuration. The towable implement comprises a field locking mechanism for selectively locking the tongue in the unfolded position. The field locking mechanism includes a spring that is manually shiftable between a locking position for maintaining the tongue in the unfolded position and a releasing position for permitting shifting of the tongue out of the unfolded position.

Another aspect of the present invention concerns a method of operating a towable implement having a frame, transport wheels attached to the frame, field wheels attached to the frame, and a folding tongue pivotally attached to the frame. The method of operating comprises (a) towing the implement over a road while the implement is in an endwise transport configuration where the tongue extends outwardly from a first end of the frame in a folded position and the bottom of the transport wheels are lower than the bottom the field wheels, (b) shifting the implement from the endwise transport configuration to a field configuration where the tongue extends outwardly from a first side of the frame in an unfolded position and the bottom of the field wheels are lower than the bottom the transport wheels, and (c) pulling the implement in a field with a prime mover attached to the tongue of the implement while the implement is in the field configuration. The shifting of step (b) includes (i) lowering the transport wheels from a raised position to a lowered position using at least one transport wheel actuator, (ii) pivoting the tongue from the folded position to the unfolded position using at least one tongue actuator, (iii) moving a brace member from a collapsed configuration to a supporting configuration using an alignment bar pivotally coupled to the brace bar and tongue, and (iv) locking the brace member in the supporting configuration using a field locking mechanism. The lowering, pivoting, moving, and locking are carried out without manual manipulation of the transport wheels, tongue, brace member, alignment bar, or field locking mechanism.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

FIG. 1 is a perspective view of a towable implement (specifically, an agricultural box drill) in a field configuration.

FIG. 2 is a perspective view of the towable implement in an endwise transport configuration.

FIG. 3 is a side view of the towable implement depicting how the transport wheels are raised and lowered when the implement is shifted between the field configuration and the endwise transport configuration.

FIG. 4 is a top view of the towable implement illustrating the manner in which the tongue shifts between an unfolded position (when the implement is in the field configuration) and a folded position (when the implement is in the endwise transport configuration).

FIG. 5 is a top enlarged view depicting the tongue in various positions during folding/unfolding and showing the mechanisms for locking the tongue in the folded and unfolded positions.

FIG. 6 is an enlarged perspective view depicting the tongue immediately prior to entering the unfolded position and being locked into the unfolded position by a field locking mechanism that couples the unfolded tongue to a brace bar.

FIG. 7a is an enlarged perspective view depicting the field locking mechanism coupling the brace bar to the tongue, with the spring of the field locking mechanism being in a locking position.

FIG. 7b is an enlarged perspective view similar to FIG. 7a, but with the field locking mechanism being unlocked, with its spring in a releasing position.

FIG. 8 is a hydraulic circuit diagram depicting various hydraulic components of the towable implement and the prime mover that allow the implement to be automatically shifted between the field configuration and the endwise transport configuration using input components located on or in the prime mover.

FIG. 9a is a flow diagram showing the major steps involved in shifting the implement from the endwise transport configuration to the field configuration.

FIG. 9b is a flow diagram showing the major steps involved in shifting the implement from the field configuration to the endwise transport configuration.

### DETAILED DESCRIPTION

It is noted that the drawings included herewith depict a box drill as the towable implement employing the present invention. It should be understood, however, that this invention can be implemented on a variety of different types of towable implements, especially implements whose design is not amenable to being folded for over-the-road transport. Towable implements incorporating the present invention can be used for a variety of purposes, including agricultural uses (e.g., planting, tilling, treating, and harvesting), construction uses (e.g., soil grading, pulverizing, and compacting), or other land maintenance uses (e.g., spraying and mowing).

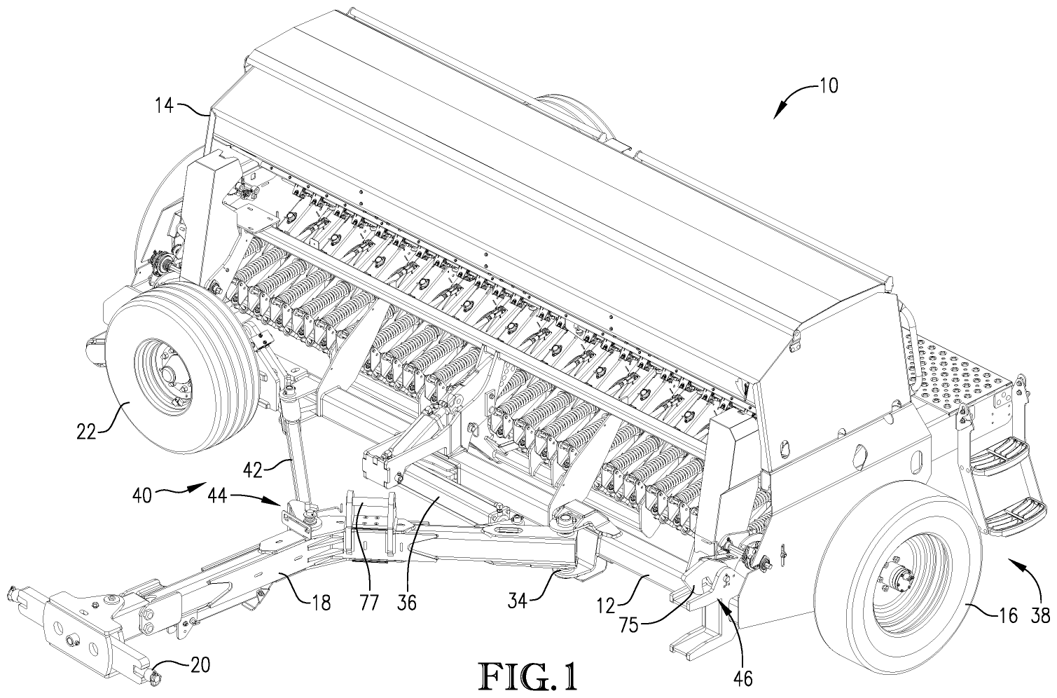

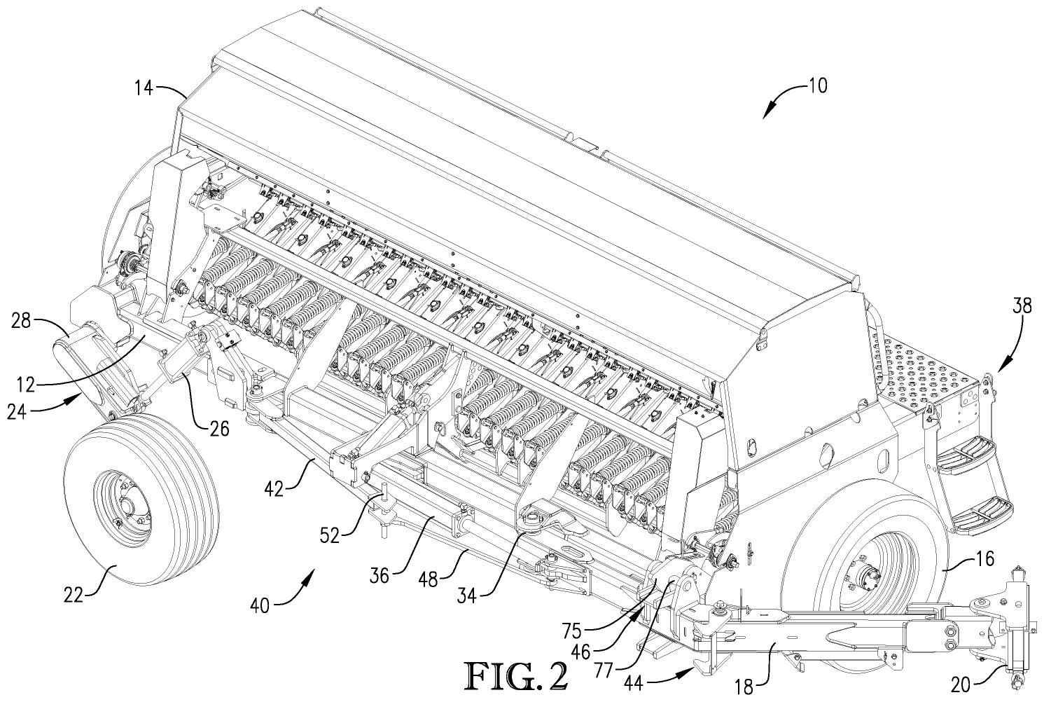

FIGS. 1 and 2 depict a towable implement 10 configured in accordance with one embodiment of the present invention. FIG. 1 shows the towable implement 10 in a field configuration, while FIG. 2 shows the towable implement 10 in an endwise transport configuration.

The towable implement 10 includes a frame 12 and one or more work mechanisms 14 attached to the frame. The entirety of the implement's 10 frame 12 is rigid (i.e., not collapsible, foldable, etc.). In the embodiment depicted in the drawings, the work mechanisms 14 include various components of a seed drill (e.g., box seeder) for planting seeds, typically in an agricultural field. However, in other embodiments, the work mechanisms 14 could be configured to perform various other work tasks, such as tilling, treating, harvesting, mowing, grading, spraying, fertilizing, etc. Additionally, it should be noted that the term “field,” as used herein, is not limited to an agricultural field, but includes any location (e.g., a construction site, a golf course, a park, etc.) where the implement is being used to perform its intended function.

The towable implement 10 includes a plurality of field wheels 16 coupled to the frame 12 and configured to support the towable implement 10 for movement on the ground in the field. The towable implement 10 also includes a folding tongue 18 configured to be attached via a hitch 20 to a prime mover, such as a tractor (not illustrated).

The towable implement 10 also includes a plurality of transport wheels 22 coupled to the frame 12 and configured to support the towable implement 10 when transported over a road. FIG. 1 shows the transport wheels 22 in a raised position, while FIG. 2 shows the transport wheels 22 in a lowered position. FIG. 1 shows the folding tongue 18 in an unfolded position, while FIG. 2 shows the folding tongue 18 in a folded position. Thus, when the implement 10 is in the field configuration shown in FIG. 1, the tongue 18 is in the unfolded position and the transport wheels 22 are in the raised position. When the implement 10 is in the endwise transport configuration shown in FIG. 2, the tongue 18 is in the folded position and the transport wheels 22 are in the lowered position. Thus, in certain embodiments, the towable implement 10 uses different sets of wheels (i.e., the field wheels 16 and the transport wheels 22) with different orientations for field use and road use. Unlike certain conventional folding tongue implements, the wheels of the implement 10 described herein have a fixed orientation relative to the frame, with the field wheels 16 being oriented perpendicular to the transport wheels 22. Additionally, unlike certain conventional adjustable width implements, the folding tongue 18 of the implement 10 described herein is a rigid member that does not collapse, disassemble, telescope, or fold on itself; rather, the tongue 18 only pivots relative to the frame 12.

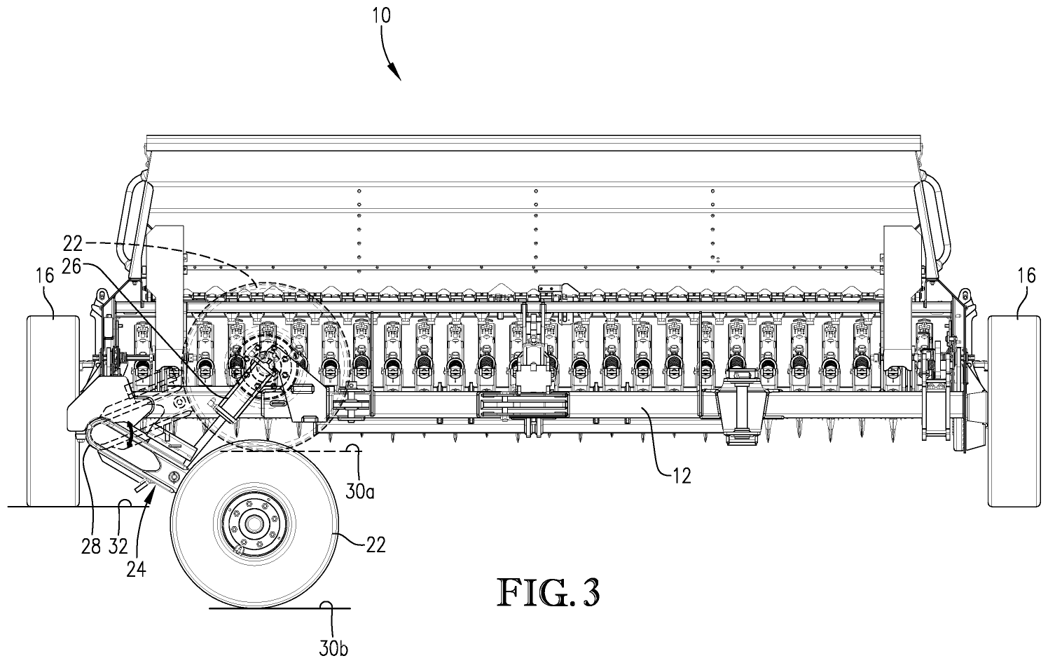

Referring now to FIGS. 1-3, the towable implement 10 includes a transport wheel shifting mechanism 24 (shown in FIGS. 2 and 3) for shifting the transport wheels 22 relative to the frame 12 between the raised position (FIG. 1 and dashed lines in FIG. 3) and lowered position (FIG. 2 and solid lines in FIG. 3). The transport wheel shifting mechanism 24 is coupled to the frame 12 near a rear end of the frame 12. The rear end of the frame 12 is opposite the front end 38 of the frame 12 where the tongue 18 folds for endwise transport. The transport wheel shifting mechanism 24 can include at least one transport wheel actuator 26 and a rockshaft mechanism 28. The rockshaft mechanism 28 is pivotably coupled to the frame 12 and supports the transport wheels 22 on the frame 12. The transport wheel actuator 26 is pivotable coupled to and extends between the frame 12 and the rockshaft mechanism 28. The transport wheel actuator 26 is shiftable between an extended position (FIG. 2 and solid lines in FIG. 3) and a retracted position (FIG. 1 and dashed lines in FIG. 3).

Referring now to FIG. 3, when the transport wheel actuator 26 is in the retracted position, the transport wheels 22 are in the raised position (dashed lines) with the bottom 30a of the transport wheels 22 being vertically positioned higher than the bottom 32 of the rear field wheel 16. When the transport wheel actuator 26 is in the extended position, the transport wheels 22 are in the lowered position (solid lines) with the bottom 30b of the transport wheels 22 being vertically positioned lower than the bottom 32 of the rear field wheel 16. In one embodiment of the present invention, the transport wheel actuator 26 is a hydraulic cylinder, but various other actuators can be used to cause raising and lowering of the transport wheels 22.

Referring to FIGS. 1, 2, and 4 the towable implement 10 includes a number of components configured to facilitate movement of the folding tongue 18 between the unfolded position (FIG. 1) and the folded position (FIG. 2), as well as locking of the tongue 18 in the unfolded position (FIG. 1) and the folded position (FIG. 2). Specifically, the folding tongue 18 is pivotably coupled to the frame 12 by a pivot joint 34. Pivoting of the tongue 18 relative to the frame 12 can be powered by a tongue actuator 36, which is pivotably coupled to and extends between the frame 12 and the tongue 18. When the tongue actuator 36 is retracted (FIG. 1) the tongue 18 is in the unfolded position and when the tongue actuator 36 is extended (FIG. 2) the tongue 18 is in the folded position. In one embodiment of the present invention, the tongue actuator 36 is a hydraulic cylinder, but various other actuators can be used to cause folding and unfolding of the tongue 18.

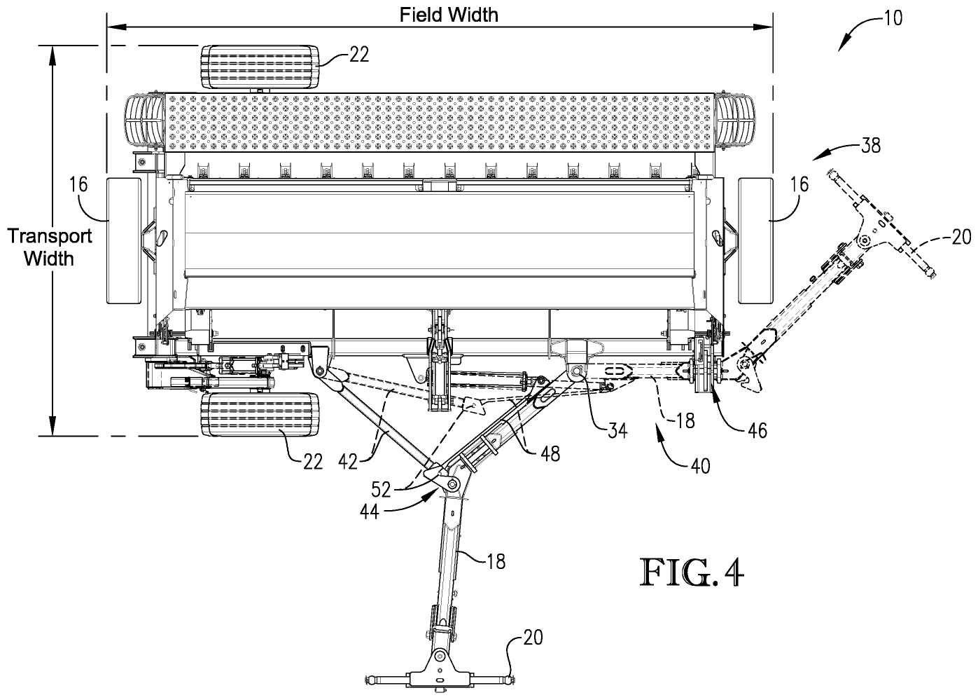

As shown in FIGS. 1 and 4, when the tongue 18 is in the unfolded position, the hitch 20 of the tongue 18 extends outwardly from a first side 40 of the towable implement 10. As shown in FIGS. 2 and 4, when the tongue 18 is in the folded position, the hitch 20 of the tongue 18 extends outwardly from a first/front end 38 of the towable implement 10. In the folded position, a prime mover (not shown) can be attached to the hitch 20 of the folded tongue 18 so that the towable implement 10 can be pulled lengthwise over the road using the lowered transport wheels 22. In the unfolded position, the prime mover can be attached to the hitch 20 of the tongue 18 so that the towable implement 10 can be pulled widthwise in the field using the field wheels 16. When shifted between the folded and unfolded positions, the tongue 18 pivots through an angle of at least 80, 90, 100, 110, or 120 degrees and/or not more than 170, 160, 150, or 140 degrees. In the illustrated embodiment, the tongue pivots through an angle of about 140 degrees when folded and unfolded.

Referring to FIG. 4, the field width of the towable implement 10, which is the maximum width of the implement 10 in the field configuration, is substantially greater than the transport width of the towable implement 10, which is the maximum width of the implement 10 in the endwise transport configuration. In certain embodiments, the ratio of the field width to the transport width can be at least 1.25:1, at least 1.5:1, at least 1.75:1, or at least 2:1.

Referring to FIGS. 1-5, the towable implement 10 can include a brace bar 42 for supporting/bracing the folding tongue 18 in the unfolded position. The brace bar 42 is pivotally coupled to the frame 12 at a proximal end of the brace bar 42. A distal end of the brace bar 42 contacts and is locked into place with the folding tongue 18 when the tongue 18 is in the unfolded position. A field locking mechanism 44 is used to couple the distal end of the brace bar 42 to the folding tongue 18 when the tongue 18 is in the unfolded position. When the tongue 18 is in the folded position, a transport locking mechanism 46 is used to releasably couple the folding tongue 18 to the frame 12. Both the field locking mechanism 44 and the transport locking mechanism 46 can be automatic (e.g., spring-loaded) locking mechanisms that do not require manual input to engage and lock two components to one another. However, as described in further detail below, in certain embodiments, both the field locking mechanism 44 and transport locking mechanism 46 may require some manual manipulation for shifting between an open/releasing configuration and a closed/locking configuration, especially when the locking mechanisms 44,46 are spring locks that employ two-position springs. However, it is possible for the shifting of the two-position springs to be automated using, for example, electric, hydraulic, or pneumatic actuators.

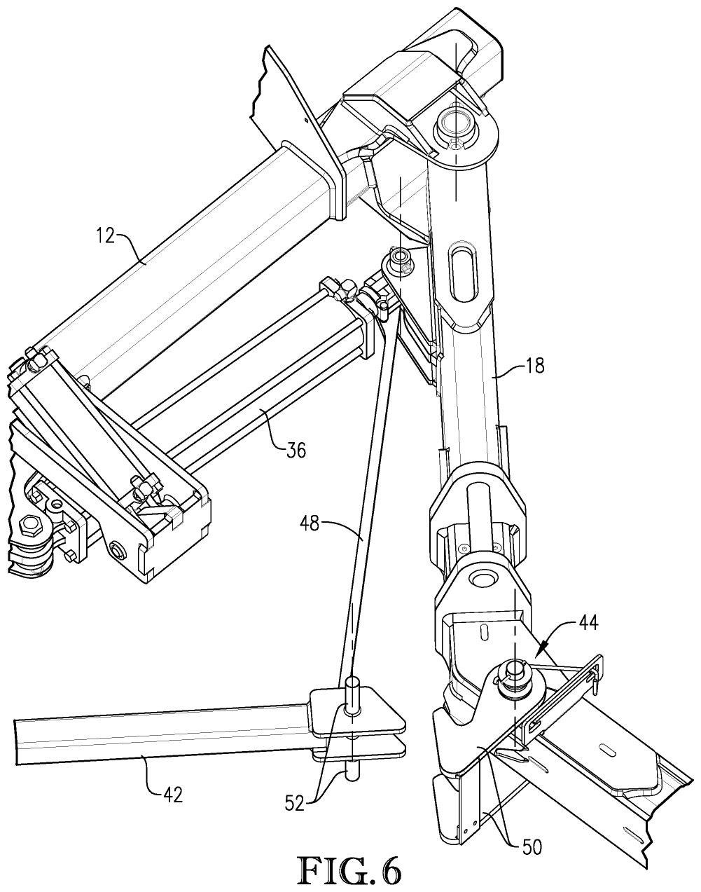

As shown in FIGS. 2, 4, and 5, an alignment bar 48 includes a first end that is pivotally coupled to the distal end of the brace bar 42 and a second end that is pivotally coupled to the tongue 18. In the illustrated embodiment, the second end of the alignment bar 48 is connect to the tongue 18 at the same location (i.e., on the same axis and/or with same pin) where the tongue actuator 36 is connected to the tongue 18. When the folding tongue 18 is shifted from the unfolded position to the folded position, the alignment bar 48 pulls the brace bar 42 toward the first side 40 of the frame 12 and holds the brace bar 42 close to the frame 12 while the tongue 18 is locked in the folded position. When the folding tongue 18 is shifted from the folded position to the unfolded position, the alignment bar 48 pushes the brace bar 42 away from the first side 40 of the frame 12 and, as perhaps best shown in FIG. 6, positions the distal end of the brace bar 42 in alignment with the field locking mechanism 44 for locking of the brace bar 42 to the tongue 18.

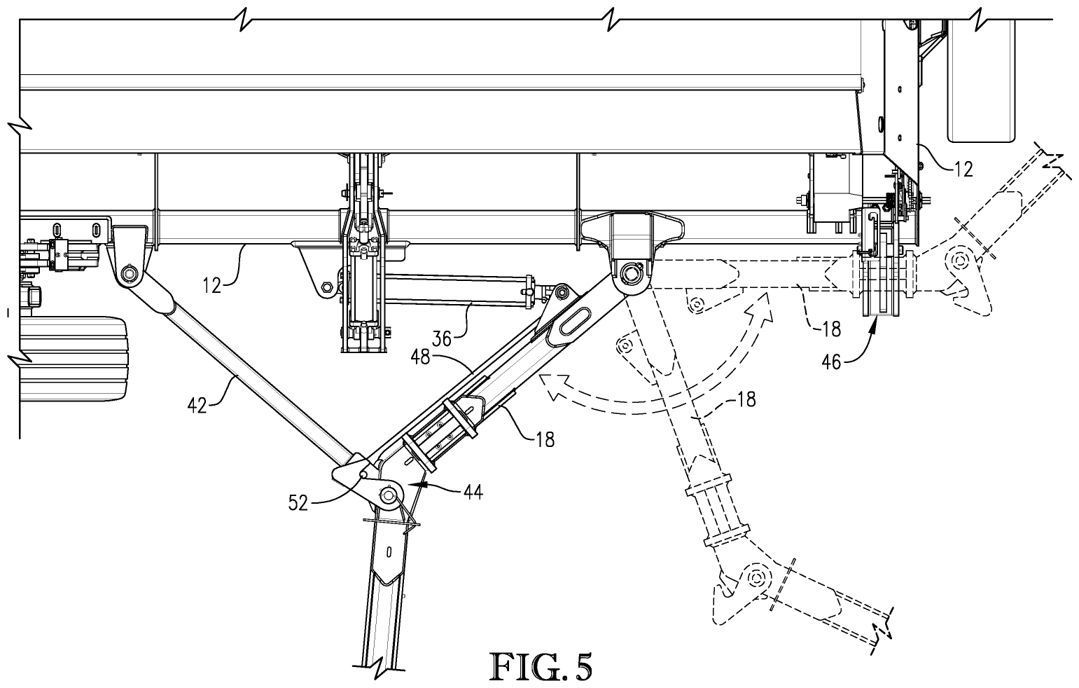

As shown in FIGS. 4 and 5, the tongue 18 comprises a first substantially straight tongue segment (closest to the frame 12) and a second substantially straight tongue segment (farthest from the frame 12). The first and second segments of the tongue 18 are fixed to one another at or near the location where the brace bar 42 contacts the tongue 18 in the unfolded position. The first and second segments of the tongue 18 are angled relative to one another at an angle in the range of 100 to 170 degrees, 110 to 160 degrees, or 120 to 150 degrees. When the tongue 18 and the brace bar 42 are locked to one another in the field configuration, the segments of the tongue 18 and the brace bar 42 form a Y shape, with the two arms of the Y shape being formed by the brace bar 42 and the first tongue segment.

As shown in FIGS. 5-7 the field locking mechanism 44 includes a shiftable locking member 50 and a fixed locking member 52. In the illustrated embodiment, the shiftable locking member 50 is shiftably coupled to the folding tongue 18, while the fixed locking member 52 is rigidly coupled to the distal end of the brace bar 42. However, it is possible for this to be reversed, with the shiftable locking member 50 being shiftably coupled to the distal end of the brace bar 42 and the fixed locking member 52 being rigidly coupled to tongue 18.

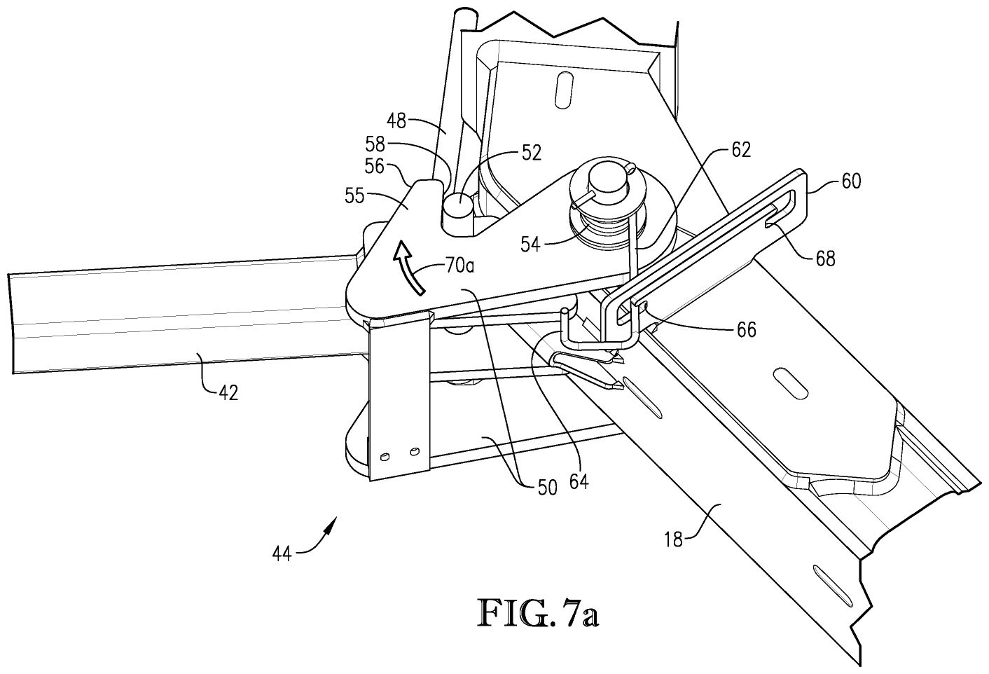

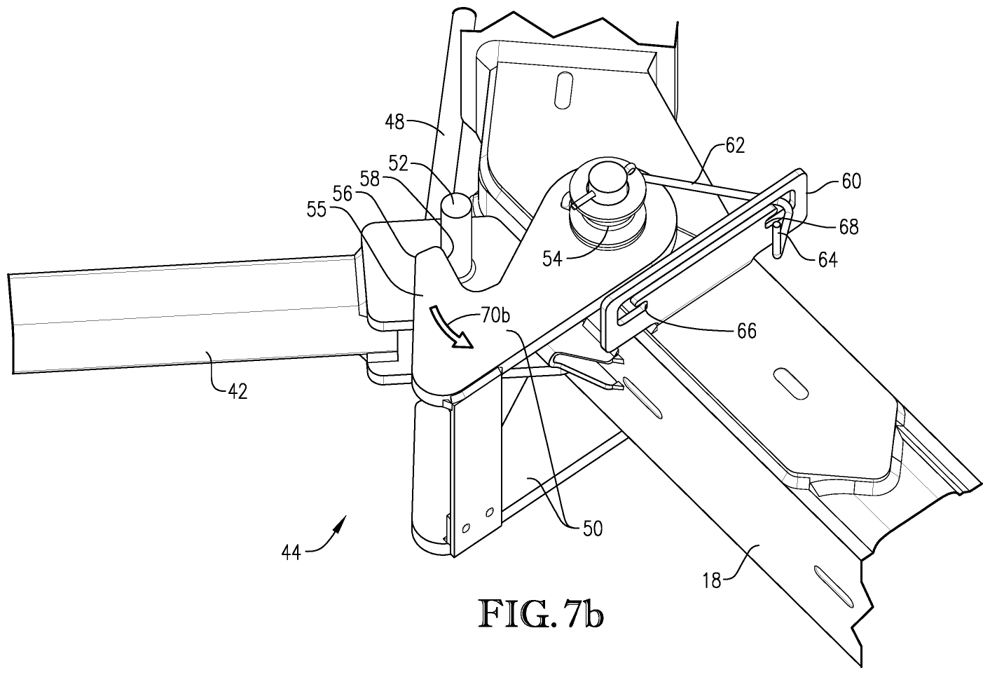

Referring now to FIGS. 7a and 7b, the field locking mechanism 44 includes a spring 54 that can bias the shiftable locking member 50 to rotate in a locking direction 70a toward the fixed locking member 52, so that the shiftable locking member 50 can capture and hold the fixed locking member 52 to thereby lock the tongue 18 in the unfolded position. In more detail, the shiftable locking member 50 can include a projection 55 that presents a displacement surface 56 on one side and a holding surface 58 on another side. Further, the field locking mechanism 44 can include a spring positioning structure 60 that is coupled to the tongue 18 and receives a movable extension element 62 of the spring 54. The movable extension element 62 of spring 54 includes a spring handle 64 that allows the spring to be manually shifted between a locking position (shown in FIG. 7a) and an unlocking position (shown in FIG. 7b). The spring positioning structure 62 can include a locking spring stop 66 and a releasing spring stop 68 that are spaced apart from one another and are used to retain the spring 54 in the locking and releasing positions, respectively. In one embodiment, the locking and releasing spring stops 66,68 are spaced from one another by 0.5 to 6 inches, 1 to 5 inches, or 1.5 to 4 inches. In one embodiment, the spring 54 is a torsion spring that includes a central coil extending along a central coil axis, the movable extension element 62 extending from one end of the coil, and a biasing extension element (not illustrated) extending from an opposite end of the coil. The biasing extension element extends away from the coil axis and is coupled to the shiftable locking member 50. The movable extension element 62 extends away from the coil axis toward the spring positioning structure 60.

As shown in FIG. 7a, when the spring 54 is in the locking position with the movable extension element 62 engaging the locking spring stop 66, the shiftable locking member 50 is biased by the spring 54 in a locking direction 70a. As shown in FIG. 7b, when the spring 54 is in the releasing position with the movable extension element 62 engaging the releasing spring stop 68, the shiftable locking member 50 is biased by the spring 54 in a releasing direction 70b.

As shown in FIG. 7a, when the spring 54 is in the locking position and biasing the shiftable locking member in the locking direction 70a, the field locking mechanism 44 is configured to automatically receive and hold the fixed locking member 52, thereby locking the distal end of the brace bar 42 in contact with the tongue 18. In more detail, when the folding tongue 18 is being shifted from the folded position to the unfolded position and the fixed locking member 52 approaches the shiftable locking member 50 biased by the spring 54 in the locking direction 70a, the fixed locking member 52 engages the displacement surface 56 of the shiftable locking member 50 and causes the shiftable locking member 50 to rotate against the bias of the spring 54 (i.e., opposite the locking direction 70a) until the fixed locking member 52 moves past the displacement surface 56. Once the fixed locking member 52 has moved past the displacement surface 56, the shiftable locking member 50 is rotated in the locking direction 70a toward the fixed locking member 52 by the force of the spring 54 until the fixed locking member 52 is captured and held against the holding surface 58 of the shiftable locking member 50. Thus, no manual manipulation of any locking components is necessary to lock the brace bar 42 and the tongue 18 to one another as the tongue 18 is shifted into the unfolded position.

As shown in FIG. 7b, when it is desired to shift the folding tongue 18 out of the unfolded position and into the folded position, the spring handle 64 can be used to manually move the movable extension element 62 from the locking spring stop 66 to the releasing spring stop 68. Moving the spring extension element 62 to the releasing spring stop 68 causes the shiftable locking member 50 to be biased by the spring 54 to rotate in a releasing direction 70b away from the fixed locking member 52. Once the spring 54 has been placed in the releasing position, the shiftable locking member 50 may automatically rotate in the releasing direction 70b. Alternatively, if the implement is in a position where the fixed locking member 52 is exerting a binding force against the holding surface 58 of the shiftable locking mechanism 50, it may be necessary to move the prime mover back and forth to relieve the binding force and allow the spring 54 to automatically shift the shiftable locking member 50 out of engagement with the fixed locking member 52, thereby decoupling the brace bar 42 and the tongue 18 and permitting the tongue 18 to be shifted out of the unfolded position.

Although not illustrated in as much detail, the transport locking mechanism 46 can have the same or a similar configuration as the field locking mechanism 54. Thus, as shown in FIGS. 1 and 2, the transport locking mechanism 46 can include a shiftable locking member 75 that is pivotally coupled to the frame 12 of the implement and a fixed locking member 77 that is rigidly couple to the tongue 18. Alternatively, the shiftable locking member 75 of the transport locking mechanism 46 can be pivotally coupled to the tongue 18 and the fixed locking member 77 can be rigidly coupled to the frame 12. The transport locking mechanism 46 can also include an adjustable spring that is manually positionable between a locking position and a releasing position. When the spring of the transport locking mechanism 46 is in the locking position, the shiftable locking member 75 is biased in a locking direction. When the spring of the transport locking mechanism 46 is in the releasing position, the shiftable locking member 75 is biased in a releasing direction that is opposite of the locking direction. Thus, to lock the tongue 18 to the frame 12, the spring of the transport locking mechanism must be in the locking position so that that when the tongue 18 moves into the folded position, the transport locking mechanism 46 automatically locks the tongue 18 to the frame 12. To release the tongue 18 from the frame 12, the spring of the transport locking mechanism 46 is manually shifted into the releasing position, so that the shiftable locking member 75 of the transport locking mechanism 46 moves out of engagement with the fixed locking member 77, thereby permitting the tongue 18 to move out of the folded position and away from the frame 12. Although the embodiment illustrated in the drawings employs manual shifting of the field and transport locking mechanisms 44,46 between their releasing and locking positions, it should be understood that various types of actuators (hydraulic, electric, pneumatic, etc.) can be used to automatically shift the locking mechanisms 44,46 between the releasing and locking positions.

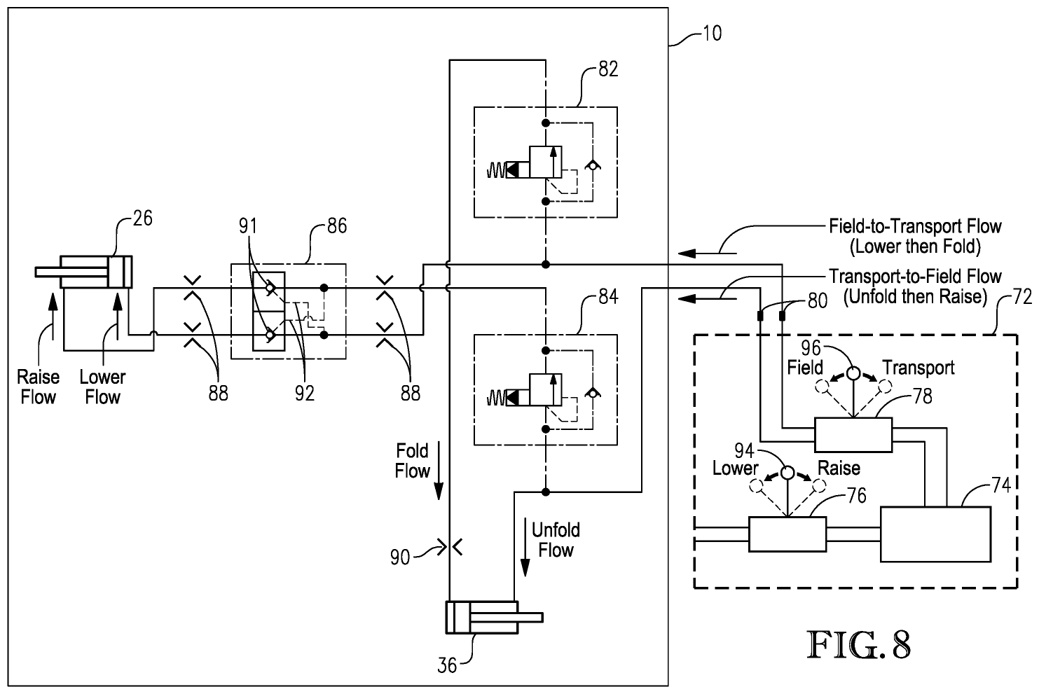

FIG. 8 shows a hydraulic circuit of the towable implement 10 and a prime mover 72 pulling the implement 10. The hydraulic system of the prime mover 72 includes a pressurized hydraulic fluid source 74, a hitch (e.g., 3-point hitch) hydraulic controller 76, and an implement hydraulic controller 78. The hydraulic controllers 76,78 includes operator input mechanisms 94,96 for receiving operator inputs. The operator input mechanisms 94,96 can be, for example, a lever, a switch, a button, a touchscreen, or a microphone for receiving voice commands. If the prime mover 72 is driver-less, the operator input can be remote to the prime mover 72 or can be a programmed into the prime mover 72.

Referring again to FIG. 8, hydraulic connectors 80 releasably connect the hydraulic system of the prime mover 72 to the hydraulic circuit of the implement 10. The hydraulic circuit of the implement 10 includes a first control valve 82, a second control valve 84, a transport wheel safety valve 86, a plurality of transport wheel flow restrictors 88, a tongue flow restrictor 90, the transport wheel actuator 26, and the tongue actuator 36.

In the illustrated embodiment, the transport wheel safety valve 86 is a double pilot-operated check valve that includes two individual check valves 91 and two individual pilot lines 92. The transport wheel safety valve 86 acts as a hydraulic lock for the transport wheels 22 by preventing any hydraulic fluid from flowing out of the transport wheel actuator 26 when the hydraulic circuit is inactive. For example, when the transport wheels 22 are fully raised for field operation or fully lowered for transport over the road, the safety valve 86 prevents flow of hydraulic fluid out of the transport wheel actuator 26, thereby fixing the position of the transport wheels 22 until the hydraulic circuit is activated to shift out of the transport or field configuration. The transport wheel flow restrictors 88 are configured to prevent rapid up or down movement of the transport wheel 22. Similarly, the tongue flow restrictor 90 prevents rapid rotation of the tongue 18 and frame 12 relative to one another.

In the embodiment illustrated in FIG. 8, the first and second control valves 82,84 are each pilot operated pressure relief valves that open to permit actuator supply flow therethrough when a threshold pressure is reach. As described in more detail below, the first and second control valves 82,84 enable automatic sequential movement of the tongue 18 and transport wheels 22 in response to a single operator input. More specifically, upon receiving a single “transport” operator input at operator input mechanism 96, the first and second control valves 82,84 first facilitate lowering of the transport wheels 22 with the transport actuator 26 followed by folding of the tongue 18 with the tongue actuator 36. Upon receiving a single “field” operator input at operator input mechanism 96, the first and second control valves 82,84 first facilitate unfolding of the tongue 18 with the tongue actuator 36 followed by raising of the transport wheels 22 with the transport wheel actuator 26.

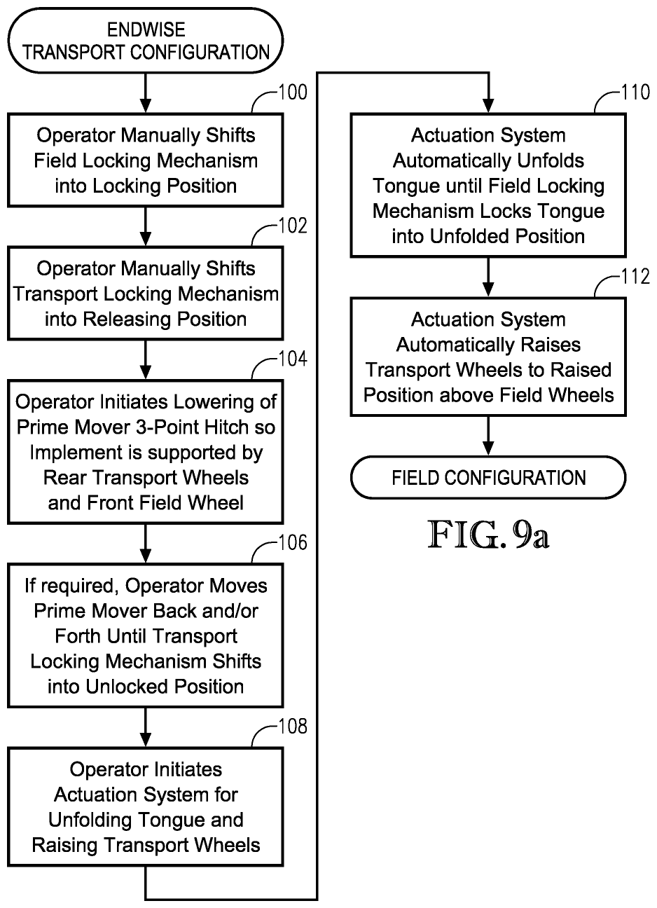

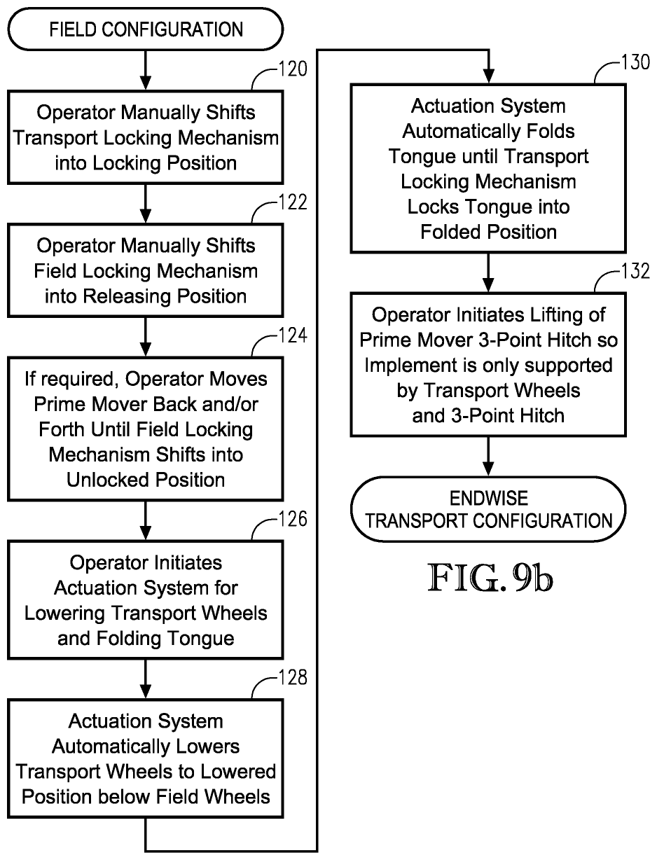

FIG. 9a outlines the main steps involved in shifting the towable implement 10 from the endwise transport configuration to the field configuration. In the starting endwise transport configuration, the implement 10 has (1) the tongue 18 locked in the folded position by the transport locking mechanism 46, (2) the transport wheels 22 hydraulically locked in the lowered position by the safety valve 86, (3) the transport locking mechanism 46 in the closed/locking position, (4) the field locking mechanism 44 in an open/releasing position, (5) the weight of the implement 10 supported by the rear transport wheels 22 and the tongue 18 attached to the movable hitch (e.g., 3-point hitch) of the prime mover 72, and (6) the hydraulic circuit of the implement 10 connected to the hydraulic system of the prime mover 72 by the hydraulic connectors 80.

In step 100, the operator manually shifts the field locking mechanism 44 from the open/releasing position into the closed/locking position by manually moving the movable extension member 62 of the field locking spring 54 from the releasing position shown in FIG. 7b to the locking position shown in FIG. 7a. However, as discussed above, it is possible for the implement 10 to be equipped with automated actuators that allow this shifting of the field locking mechanism 44 from the releasing position to the locking position to be performed without manual manipulation of the field locking spring 54.

In step 102, the operator manually shifts the transport locking mechanism 46 from the closed/locking position into the open/releasing position. As discussed above, the transport locking mechanism 46 can have a similar configuration to the field locking mechanism 44, which is illustrated in detail in FIGS. 6-7b. Shifting of the transport locking mechanism 46 from the closed/locking position into the open/releasing position can be carried out by manually moving the movable extension element of the transport locking spring from the locking position to the releasing position. This either moves the shiftable locking member 75 in the releasing direction and out of engagement with the fixed locking member 77 or, if the shiftable locking member 75 and fixed locking member 77 are bound up with one another, biases the shiftable locking member 75 in the releasing direction without moving the shiftable locking member 75. As discussed above, it is possible for the implement 10 to be equipped with automated actuators that allow this shifting of the transport locking mechanism 46 from the locking position to the releasing position to be performed without manual manipulation of the transport locking spring.

In step 104, the operator initiates lowering of the movable hitch (e.g., 3-point hitch) of the prime mover 72 by providing an operator input to an input device 94 (e.g., a lever, switch, button, touchscreen, or microphone for receiving voice commands) operably coupled to the hitch hydraulic controller 76 on/in the prime mover 72. When the movable hitch is lowered, the tongue 18 of the implement 10 is lowered until the front field wheel 16 (i.e., the field wheel 16 located closest to the first end 38 of the frame 12) contacts the ground so that the weight of the implement 10 is supported by the rear transport wheels 22 and the front field wheel 16. Having the front of the implement 10 supported on the front field wheel 16 relieves the tongue 18 from supporting the weight of the implement 10, which allows the tongue 18 to be readily pivoted relative to the frame 12.

In step 106, if the shiftable locking member 75 and the fixed locking member 77 of the transport locking mechanism 46 are bound up with one another, the operator moves the prime mover 72 back and forth until the shiftable locking member 75 of the transport locking mechanism 46 is shifted into the unlocked position by the urging of the transport lock spring in the releasing direction. Thereafter, the prime mover 72 is placed in neutral for unfolding of the tongue 18.

In step 108, the operator initiates the actuation system for sequentially unfolding the tongue 18 and raising the transport wheels 22. This is done by providing a single operator input to the implement input device 96 operably coupled to the implement hydraulic controller 78 on/in the prime mover 72. Upon receiving this “field” input from operator, the implement hydraulic controller 78 initiates flow of pressurized hydraulic fluid from the pressurized hydraulic fluid source 74 of the prime mover 72 to the second control valve 84 and to the head of the tongue actuator 36.

In step 110, the actuation system automatically unfolds the tongue 18 until the field locking mechanism 44 locks the tongue 18 in the unfolded position. During unfolding, the tongue actuator 36 forces rotation of the tongue 18 and frame 12 relative to one another, while the front of the implement 10 is supported on the front field wheel 16 and the rear of the implement 10 is supported on the transport wheels 22. During this step, the main body of the implement 10 can twist relative to the tongue 18 and prime mover 72.

In addition to causing rotation of the tongue 18 and frame 12 relative to one another, unfolding the tongue 18 may also cause some forward and/or rearward movement of the prime mover 72 and/or implement 10 on the ground. This is because, as the tongue 18 unfolds, the distance between the rear transport wheels 22 of the implement 10 and the prime mover 72 decreases, while the distance between the front field wheel 16 of the implement and the prime mover 72 increases. During unfolding of the tongue 18, the prime mover 72 (with its transmission in neutral) maybe be pulled slightly rearward because the orientation of the rear transport wheels 22 may cause more resistance to rotational movement than the front field wheel 16.

During step 110, pressurized hydraulic fluid is simultaneously supplied to the second control valve 84 and the head of the tongue actuator 36. While the tongue actuator 36 is unfolding the tongue 18, the second control valve 84 inhibits/blocks the flow of hydraulic fluid therethrough to the head of the transport actuator 26 and the first control valve 82 permits the flow of hydraulic fluid therethrough from the base of the transport actuator 36 back to the hydraulic system of the prime mover 72. As the head of the tongue actuator 36 receives the high pressure hydraulic fluid, the tongue actuator 36 retracts, thereby causing the tongue 18 and frame 12 to rotate relative to one another. As the tongue 18 unfolds, the alignment bar 48, pushes the brace bar 42 away from the frame 12 of the implement 12 and aligns the fixed locking member 52 on the end of the brace bar 42 with the shiftable locking member 50 on the tongue 18. When the tongue actuator 36 reaches full retraction, the field locking mechanism 44 automatically locks the tongue 18 to the brace bar 42 in the unfolded position.

Once the tongue actuator 36 is fully retracted, the pressure of the hydraulic fluid supplied to the tongue actuator 36 and the second control valve 84 exceeds a second threshold pressure of the second control valve 84, thereby opening the second control valve 84. With the second control valve 84 being opened, the pressurized hydraulic fluid is supplied through the second control valve 84 to the head of the transport wheel actuator 26 to commence retraction of the transport wheel actuator 26 and raising of the transport wheels 22.

In step 112, the actuation system automatically raises the transport wheels 22 so that the bottom of the rear transport wheels 22 are raised above the bottom of the rear field wheel 16. This raising of the transport wheels 22 occurs as the pressurized hydraulic fluid flows through the safety valve 86 and into the head of the transport wheel actuator 26.

Once the transport wheels 22 are in the fully raised position, the operator can cease providing the “field” input at the implement input device 96 so that the implement hydraulic controller 78 terminates the flow of hydraulic fluid to the implement 10. In the resulting field configuration, the tongue 18 is mechanically locked in the unfolded position by the field locking mechanism 44 and the transport wheels 22 are hydraulically locked in the raised position by the safety valve 86. The safety valve includes a pair of pilot operated check valves 91 that prevent hydraulic fluid from exiting the base and head of the transport actuator 26 when pressurized hydraulic fluid is not being supplied to the safety valve 86 from the prime mover 72. During operation of the implement 10 in the field configuration, the hydraulic circuit depicted in FIG. 8 is not used.

FIG. 9b outlines the key steps involved in shifting the towable implement 10 from the field configuration to the endwise transport configuration. In the starting field configuration, the implement 10 has (1) the tongue 18 locked in a unfolded position by the field locking mechanism 44, (2) the rear transport wheels 22 raised and hydraulically locked in the raised position by the safety valve 86, (3) the field locking mechanism 44 in a closed/locking position, (4) the transport locking mechanism 46 in an open/releasing position, (5) the weight of the implement 10 supported by the field wheels 16 and unfolded tongue 18 attached to the movable hitch (e.g., 3-point hitch) of the prime mover 72, and (6) the hydraulic circuit of the implement 10 connected to the hydraulic system of the prime mover 72 by the hydraulic connectors 80.

In step 120, the operator manually shifts the transport locking mechanism 46 from the open/releasing position into the closed/locking position by manually moving the movable extension member of the transport locking spring from the releasing position to the locking position. This moves the shiftable locking member 75 of the transport locking mechanism 46 the locking direction and biases the shiftable locking member 75 in the locking direction. As discussed above, it is possible for the implement 10 to be equipped with automated actuators that allow this shifting of the transport locking mechanism 46 from the releasing position to the locking position to be performed without manual manipulation of the transport locking spring.

In step 122, the operator manually shifts the field locking mechanism 44 from the closed/locking position into the open/releasing position by manually moving the movable extension member 62 of the field locking spring 54 from the locking position shown in FIG. 7a to the releasing position shown in FIG. 7b. If the shiftable locking member 50 and the fixed locking member 52 are not bound in the locked position, shifting the movable extension member 62 into the releasing position causes the shiftable locking member 50 to rotate in the releasing direction 70b and out of engagement with the fixed locking member 52. However, if the shiftable locking member 50 and the fixed locking member 52 are bound in the locked position, shifting the movable extension member 62 into the releasing position causes tension in the field locking spring 54 that biases/urges the shiftable locking member 50 toward the releasing direction 70b. As discussed above, it is possible for the implement 10 to be equipped with automated actuators that allow this shifting of the field locking mechanism 44 from the locking position to the releasing position to be performed without manual manipulation of the field locking spring 54.

In step 124, if the shiftable locking member 50 and the fixed locking member 52 remain bound in the lock position after step 122, the operator can move the prime mover 72 back and forth to until the field locking mechanism 44 becomes unbound and shifts into the open/unlocked position. Moving the prime mover 72 back and forth unbinds the shiftable locking member 50 and the fixed locking member 52, thereby allowing the field locking spring 54 to move the shiftable locking member 50 in the releasing direction 70b to the releasing position. Thereafter, the transmission of the prime mover 72 can be placed in neutral.

In step 126, the operator initiates the actuation system for sequentially lowering the transport wheels 22 and folding the tongue 18. This is done by providing a single operator input to an implement input device 96 operably coupled to the implement hydraulic controller 78. This “transport” operator input at the implement hydraulic controller 78 initiates flow of pressurized hydraulic fluid from the pressurized hydraulic fluid source 74 to the first control valve 82, through the safety valve 86, and to the base of the transport wheel actuator 26.

In step 128, the actuation system automatically lowers the transport wheels 22 to the lowered position so that the bottom 30b of the transport wheels 22 are below the bottom 32 of the rear field wheel 22. During this step, pressurized hydraulic fluid flows past the first control valve 82, through the safety valve 86, and into the base of the transport wheel actuator 26. More specifically, before entering the base of the transport wheel actuator 26, the hydraulic fluid passes through a first passage and a first one of the check valves 91 of the safety valve 86. Transmission of the hydraulic fluid through the first passage of the safety valve 86 pilots open (via one of the pilot lines 92) a second one of the check valves 91 of a second passage of the safety valve 86, thereby allowing hydraulic fluid to flow out of a head of the transport wheel actuator 26, back through the safety valve 86, through the second control valve 84, and back to the hydraulic system of the prime mover 72.

As pressurized hydraulic fluid is charged to the base of the transport wheel actuator 26, the transport wheel actuator 26 extends toward full stroke and the transport wheels 22 are lowered relative to the frame 12. While the transport wheel actuator 26 is lowering the transport wheels 22, the first control valve 82 inhibits/blocks the flow of hydraulic fluid therethrough to the base of the tongue actuator 36 and the second control valve 84 permits the flow of hydraulic fluid therethrough from the head of the transport wheel actuator 26 to the hydraulic system of the prime mover 72. Once the transport wheel actuator 26 reaches full stroke, the rear of the implement 10 is supported on the transport wheels 22 and the front of the implement is supported on the front field wheel 16. At this point, the pressure of the hydraulic fluid supplied to the transport wheel actuator 26 exceeds a first threshold pressure of the first control valve 82, thereby opening the first control valve 82. With the first control valve 82 being opened, the pressurized hydraulic fluid is supplied through the first control valve 82 to the base of the tongue actuator 36 to commence extension of the tongue actuator 36 and folding of the tongue 18.

In step 130, the actuation system automatically folds the tongue 18 (thereby twisting the main body of the implement 10 relative to the tongue 18 and prime mover 72) until the transport locking mechanism 46 locks the tongue 18 in the folded position. As mentioned above, when the first control valve 82 has been opened by the first threshold pressure being exceeded, the first control valve 82 permits flow of s the pressurized hydraulic fluid to the base of the tongue actuator 36 to extend the tongue actuator 36 and fold the tongue 18. As the extending tongue actuator 36 folds the tongue 18, this folding force causes the tongue 18 and the implement 10 to rotate relative to one another, while being supported on the two rear transport wheels 22 and the front field wheel 16 (with the rear field wheel 16 being lifted off the ground). Additionally, as the tongue 18 folds, the alignment bar 48, pulls the brace bar 42 toward the frame 12 of the implement 10. When the tongue actuator 36 reaches full extension, the transport locking mechanism 46 automatically locks the tongue 18 to the frame 12 in the folded position.

In step 132, the operator initiates lifting of the prime mover's movable hitch (e.g., 3-point hitch) to raise the front field wheel 16 off the ground, so that the implement 10 is only supported by the rear transport wheels 22 and tongue 18 attached to the movable hitch of the prime mover 72. The operator initiates raising of the prime mover's hitch by providing input at the input device 94 operably coupled to the hitch hydraulic controller 76. With the tongue 18 being folded and locked to the frame 12 and both field wheels 16 being raised off the ground and hydraulically locked by the safety valve, the implement 10 is in the endwise transport configuration and is ready to be pulled over a road.

### CLAIMS NOT LIMITED TO DISCLOSED EMBODIMENTS

Although specific embodiments of the present technology have been illustrated and described herein. The following claims should not be limited to specific features described and illustrated herein, unless the claims expressly require those specific features. For example, although certain claims may require the transport and tongue actuators to be hydraulic cylinders, claims that simply call for a transport actuator or a tongue actuator should not be limited to hydraulic cylinder, but should encompass a wide variety of linear or rotary actuators suitable for actuating the movements of the tongue and transport wheels described herein. Additionally, although the hydraulic circuit diagram of FIG. 8 illustrates a specific configuration of components for accomplishing sequential operation of the tongue and transport wheel actuators, other components may be suitable for accomplishing the same purpose. For example, rather than pilot operated valves, electronically operated valves and/or sensors could be used to direct hydraulic fluid to the proper components at the proper times.

What is claimed is:

1. A towable implement that is shiftable between a field configuration for operation in a field and an endwise transport configuration for transporting over a road, the implement comprising:
a frame;
one or more work mechanisms supported by the frame and configured to perform work in the field;
a folding tongue pivotably coupled to the frame and shiftable between an unfolded position and a folded position, wherein the tongue is in the unfolded position when the implement is in the field configuration and the tongue is in the folded position when the implement is in the endwise transport configuration; and
a brace system for supporting the tongue in the unfolded position, wherein the brace system comprises a brace bar pivotally coupled to the frame and an alignment bar pivotally coupled to the tongue, wherein the brace bar and the alignment bar are pivotally coupled to one another.

2. The towable implement of claim 1, wherein the brace bar extends between the frame and the tongue and fixes the position of the tongue relative to the frame when the tongue is in the unfolded position, wherein the brace bar does not fix the position of the tongue relative to the frame when the tongue is not in the unfolded position.

3. The towable implement of claim 2, further comprising a field locking mechanism for releasably coupling the brace bar to the tongue when the tongue is in the unfolded position, further comprising a transport locking mechanism for releasably coupling the tongue to the frame when the tongue is in the folded position.

4. The towable implement of claim 3, wherein the field locking mechanism automatically locks the brace bar to the tongue when the tongue is shifted from the folded position to the unfolded position.

5. The towable implement of claim 4, wherein the field locking mechanism is spring loaded.

6. The towable implement of claim 1, wherein the alignment bar (i) pushes the brace bar away from the frame when the tongue shifts from the folded position to the unfolded position, (ii) pulls the brace bar toward the frame when the tongue shifts from the unfolded position to the folded position, and (iii) prevents the brace bar from pivoting away from the frame when the tongue is in the folded position.

7. The towable implement of claim 6, further comprising a transport locking mechanism for selectively locking the tongue to the frame when the tongue is in the folded position, wherein the transport locking mechanism automatically locks the tongue to the frame when the tongue is shifted from the unfolded position to the folded position.

8. The towable implement of claim 1, further comprising a plurality of field wheels for supporting the implement in the field configuration and a plurality of transport wheels for supporting the implement in the endwise transport configuration, wherein the field and transport wheels are oriented for travel in different directions.

9. The towable implement of claim 8, further comprising an actuation system for automatically shifting the implement between the field configuration and the endwise transport configuration, wherein the actuation system comprises a tongue actuator for shifting the tongue between the folded and unfolded positions and a transport wheel actuator for raising and lowering the transport wheels relative to the frame.

10. The towable implement of claim 1, wherein the tongue pivots through an angle of at least 100 degrees and not more than 160 degrees when shifted between the unfolded position and the folded position.

11. A towable implement that is shiftable between a field configuration for operation in a field and an endwise transport configuration for transporting over a road, the implement comprising:
a frame;
one or more work mechanisms supported by the frame and configured to perform work in the field;
a plurality of field wheels for supporting the implement in the field configuration;
a plurality of transport wheels for supporting the implement in the endwise transport configuration;
a folding tongue pivotably coupled relative to the frame and shiftable between an unfolded position and a folded position, wherein the tongue is in the unfolded position when the implement is in the field configuration and the tongue is in the folded position when the implement is in the endwise transport configuration; and
a field locking mechanism for selectively locking the tongue in the unfolded position, wherein the field locking mechanism includes a spring that is manually shiftable between a locking position for maintaining the tongue in the unfolded position and a releasing position for permitting shifting of the tongue out of the unfolded position.

12. The towable implement of claim 11, wherein the spring is a torsion spring.

13. The towable implement of claim 12, wherein the torsion spring has a central coil extending along a central coil axis, a movable extension element extending from one end of the coil, and a biasing extension element extending from an opposite end of the coil, wherein the biasing and movable extension elements both extend away from the coil axis, wherein the movable extension element is manually shiftable between the locking position and the releasing position.

14. The towable implement of claim 13, wherein the locking mechanism includes a locking spring stop for retaining the movable extension element in the locking position and a releasing spring stop for retaining the movable extension element in the releasing position, wherein the field locking mechanism further includes a shiftable locking member, wherein the shiftable locking member is rotatable in a locking direction and a releasing direction, wherein the locking and releasing directions are opposite of one another, wherein the spring biases the shiftable locking member in the locking direction when the spring is in the locking position, wherein shifting the spring from the locking position to the releasing position urges the shiftable locking member in the releasing direction.

15. The towable implement of claim 14, wherein the field locking mechanism further comprises a fixed locking member that (i) is engaged and held by the shiftable locking member when the tongue is locked in the unfolded position and (ii) is not engaged and held by the shiftable locking member when the tongue is not in the unfolded position, further comprising a brace member pivotally coupled to the frame and supporting the tongue in the unfolded position, wherein the shiftable locking member is rotatably coupled to one of the tongue and the brace member and the fixed locking member is rigidly coupled to the other of the tongue and the brace member.

16. The towable implement of claim 15, wherein the shiftable locking member presents a displacement surface and a holding surface facing in different directions, wherein when the spring is in the locking position and the tongue is shifted from the folded position to the unfolded position (i) the fixed locking member engages the displacement surface of the latch and causes the latch to rotate in the releasing direction against the bias of the spring, (ii) the spring pivots the shiftable locking member in the locking direction until the holding surface of the latch engages the fixed locking member, and (iii) the spring holds the holding surface of the shiftable locking member in engagement with the locking pin to thereby lock the tongue in the unfolded position.

17. The towable implement of claim 16, wherein when the spring is shifted from the locking position to the releasing position, the spring urges the shiftable locking mechanism in the releasing direction so that the holding surface of the latch is released from engagement with the fixed locking member to thereby decouple the shiftable locking member and the fixed locking member.

18. The towable implement of claim 11, further comprising a transport locking mechanism for selectively locking the tongue to the frame when the implement is in the endwise transport configuration.

19. The towable implement of claim 11, further comprising an actuation system for automatically shifting the implement between the field configuration and the endwise transport configuration, wherein the actuation system comprises at least one tongue actuator for shifting the tongue between the folded and unfolded positions and at least one transport wheel actuator for raising and lowering the transport wheels relative to the frame.

20. A method of operating a towable implement having a frame, transport wheels attached to the frame, field wheels attached to the frame, and a folding tongue pivotally attached to the frame, the method comprising:
(a) towing the implement over a road while the implement is in an endwise transport configuration where the tongue extends outwardly from a first end of the frame in a folded position and the bottom of the transport wheels are lower than the bottom the field wheels;
(b) shifting the implement from the endwise transport configuration to a field configuration where the tongue extends outwardly from a first side of the frame in an unfolded position and the bottom of the field wheels are lower than the bottom the transport wheels; and
(c) pulling the implement in a field with a prime mover attached to the tongue of the implement while the implement is in the field configuration,
wherein the shifting of step (b) includes—
(i) lowering the transport wheels from a raised position to a lowered position using at least one transport wheel actuator,
(ii) pivoting the tongue from the folded position to the unfolded position using at least one tongue actuator,
(iii) moving a brace member from a collapsed configuration to a supporting configuration using an alignment bar pivotally coupled to the brace bar and tongue, and
(iv) locking the brace member in the supporting configuration using a field locking mechanism,
wherein the lowering, pivoting, moving, and locking are carried out without manual manipulation of the transport wheels, tongue, brace member, alignment bar, or field locking mechanism.

21. The method of operating a towable implement of claim 20, further comprising, prior to step (b), shifting the field locking mechanism into a field locking configuration, wherein the locking of step (iv) is accomplished by the field locking mechanism in the field locking configuration.

22. The method of operating a towable implement of claim 21, wherein the field locking mechanism is spring loaded.

23. The method of operating a towable implement of claim 22, wherein the shifting of the field locking mechanism includes manually moving a locking spring from a field locking position to a field releasing position.

24. The method of operating a towable implement of claim 20, wherein, during the towing of step (a), a transport locking mechanism locks the tongue to the frame in a folded position, wherein, during the pulling of step (c), the field locking mechanism locks the tongue in the unfolded position relative to the frame.
